(19) United States
(12) Patent Application Publication
(10) Pub. No.: US 2012/0192606 A1
(43) Pub. Date: Aug. 2, 2012

(54) METHOD AND APPARATUS FOR REMOVING AND TREATING SLUDGE FROM ANIMAL WASTE PITS

(76) Inventors: Bruce W. Quast, Waseca, MN (US); George P. Klug, New Richland, MN (US)

(21) Appl. No.: 13/016,581

(22) Filed: Jan. 28, 2011

(51) Int. Cl. B08B 1/00; C05F 3/00

(52) U.S. Cl. 71/21; 134/6; 15/93.1

(57) ABSTRACT

A dredge having an auger, a pump and a screen box is inserted into the waste pit of an animal holding structure. The rotatable auger bites into a local portion of a body of sludge on the bottom of the waste pit and puts such local sludge portion into a liquid suspension that can be pumped by the pump through the screen box and then out of the waste pit to an exterior of the structure. The screen box has a basket shaped filter screen that retains relatively large foreign debris as a spot close to the pump. The sludge pumped out of the waste pit is dewatered by a shaker table to convert the liquid suspension into a particulate material and into a liquid. The particulate material comprises the nutrient rich sludge previously on the bottom of the waste pit and can be reused as fertilizer.

### TECHNICAL FIELD

This invention relates generally to the field of agriculture and animal husbandry and, more particularly, to the handling and management of animal waste products.

### BACKGROUND OF THE INVENTION

As the population of the world increases, it has become increasingly necessary that foods of all types, whether derived from plants or animals, be efficiently and economically produced on a large scale. When one considers the production of meat products from animals, such as hogs, this requirement has led to the raising of such animals in large structures. The environment in such structures can be better controlled than an outdoor environment to exclude or minimize the presence of bacteria and viruses that might be harmful to the health of the animals contained within such structures. Thus, losses in the animal population due to death from disease can be significantly reduced, thereby increasing the yield of animals that can be produced in such a structure while simultaneously lowering the production cost per animal. Thus, an increased quantity of animals is available to meet human consumption needs while keeping the cost of the meat products derived from such animals lower than what could be obtained with more traditional methods of raising animals.

The large structures in which animals are now raised are built atop a foundation or basement that forms a waste pit for receiving and holding the waste products generated by the animals within the structure. The floors in such structures are slatted so that the waste products generated by the animals simply drop or can be washed down into the waste pit underlying the floor. This includes both liquid waste products in the form of urine and solid waste products in the form of fecal matter. Waste products of both types simply pass down through the slats in the floor and collect in the waste pit. To maximize capacity, the waste pits can be quite deep. But, no matter how deep they may be, such waste pits will eventually fill with the collected waste products.

As the waste products collect in the waste pits of such structures, the solid waste products will not completely break down. At least some portion of the solid waste products will settle to the bottom of the waste pits and form a layer of sludge. The liquid waste products will collect in a liquid layer atop the sludge. Often, at least in the early years of the life of the structure, the liquid layer of waste products will be significantly deeper than the sludge at the bottom of the waste pit. But, the sludge over time will get deeper and deeper as more sludge is created by the addition of solid waste products to the waste pit.

It has been possible in the past to effectively remove the liquid layer of waste products from the waste pit by pumping such liquid waste products out of the waste pit. In fact, the structures are built with fairly small clean out ports or openings providing access to the waste pits for this very purpose, namely to allow the introduction of hoses into the waste pits to permit the liquid waste products to be pumped out. This pump out process must be done periodically as the waste pit becomes filled with waste products in order to restore the holding capacity of the waste pit. If it were not done, the waste pit would eventually become completely full and the use of the structure for the raising of animals would have to be discontinued until the waste pit is emptied.

It is commonly believed by many in this field that the pump out process described above will also remove the collected sludge from the bottom of the waste pit. The Applicants have discovered that this is not true. The use of pumps is effective in emptying the liquid waste products from the waste pit. However, a vast majority of the sludge remains in place at the bottom of the pit following a pump out operation.

To the extent that others in the field have recognized the problem of sludge remaining in the waste pit, some attempts have been made to solve this problem by first directing a high pressure fluid flow into the waste pit in an attempt to stir up and agitate the sludge to put the sludge into suspension with the liquid waste products and thus allow it to be pumped out with the liquid waste products. However, the Applicants have learned that this is effective, if at all, only in a small area around each of the clean out ports with the vast majority of the bottom of the pit being unaffected by the stirring and agitating and still being covered by the sludge. To date, there is simply no effective way of removing the sludge from substantially the entire surface area of the bottom of the waste pit of an animal structure that is still being used for the production of animals.

The ultimate problem in not being able to remove the sludge from a waste pit is that the sludge layer gets deeper and deeper, thereby progressively decreasing the amount of room left for the collection of the liquid waste products that can be pumped. This manifests itself in shorter and shorter intervals between the times when a pump out operation must take place. It also means that it is more likely that the waste pit might become completely filled, thus requiring a pump out operation, in the middle of the winter when the ground in northern climates is frozen. In this situation, environmental laws and regulations prohibit a pump out operation from the waste pit and, at the very least, would require the operator of the structure to seek an emergency exemption from the EPA to permit such a pump out operation. Such situations could be avoided if an effective way could be found to remove the sludge itself from the waste pit of a structure that is still in use to thereby restore the waste pit to its full holding capacity.

Finally, the Applicants have further realized that the sludge in a waste pit is a nutrient rich material that could effectively be processed and used as a fertilizer on farm fields, if only it could be effectively removed from the waste pit in the first place. Thus, an effective method of removing the sludge from the waste pit of a structure that is in continued operation would serve dual purposes. It would restore the holding capacity of the waste pit itself, which is desirable for the reasons noted above. It would also permit the recovery and reuse of the nutrients contained in the sludge.

### SUMMARY OF THE INVENTION

One aspect of this invention comprises a method of removing sludge that has formed from solid animal waste products and that has accumulated on a bottom of a waste pit underlying a slatted floor of an animal holding structure. The waste pit also holds liquid animal waste products in addition to the accumulated sludge with both the liquid and solid animal waste products passing into the waste pit from the animals through the slatted floor. The method first comprises inserting a dredge into the waste pit. The dredge has a powered, rotatable bladed device contained within a bladed device housing with the housing having an open mouth such that the bladed device can protrude at least partially through the mouth of the bladed device housing and contact and bite into the accumulated sludge in the waste pit with the bladed device housing further having a discharge opening. The dredge also has a powered pump in fluid communication with the discharge opening of the bladed device housing. The method of this invention also rotates the bladed device within the bladed device housing for acting at any given time on a local portion of the sludge that is disposed ahead of the mouth of the bladed device housing such that the rotating bladed device breaks off the local sludge portion from a body of the sludge, puts such broken off local sludge portion into a liquid suspension with liquid contained in the waste pit, and moves such suspended local sludge portion towards the discharge opening in the bladed device housing. The method of this invention also includes operating the pump simultaneously while rotating the bladed device such that the pump substantially continuously suctions the suspended local sludge portion moving to the discharge opening in the bladed device housing out of the bladed device housing and pumps such suspended local sludge portion out of the waste pit of the structure. Finally, the method of this invention concludes with moving the dredge across the bottom of the waste pit while performing the bladed device rotating and the pump operating steps such that the dredge repeats the bladed device rotating and the pump operating steps on a plurality of local portions of the sludge to reduce the size of the body of sludge that was initially present on the bottom of the waste pit.

Another aspect of this invention relates to plant fertilizer material produced according to the above method following an additional step comprising dewatering the local sludge portion being pumped out of the structure by removing the liquid holding the local sludge portion in liquid suspension such that the local sludge portion is converted into a solid, granular material suitable for use as fertilizer.

Yet another aspect of this invention relates to an apparatus for removing sludge that has formed from solid animal waste products and that has accumulated on a bottom of a waste pit underlying a slatted floor of an animal holding structure. The apparatus comprises a dredge. The dredge comprises a dredge frame that is movably supported to allow the dredge frame to move across the bottom of the waste pit. A substantially horizontal, powered auger is rotatable within a substantially horizontal auger housing carried on the dredge frame, the auger housing having an open mouth that permits the auger to bite into and contact a local portion of a body of sludge on the bottom of the waste pit and move such local sludge portion towards a discharge opening in the auger housing. A powered pump is operatively carried on the dredge frame having an inlet in fluid communication with the discharge opening in the auger housing, the pump having an outlet with the pump being driven at sufficient force to draw a liquid suspension holding the local sludge portion broken off by the auger through the discharge opening of the auger housing, through the pump, and out through an outlet hose to a location outside of the structure. The apparatus of this invention also comprises a screen box carried atop the dredge frame for filtering the liquid suspension of the local sludge portion, the screen box having a filter screen for receiving and retaining pieces of foreign debris that may be present within the local sludge portion.

### BRIEF DESCRIPTION OF THE DRAWINGS

This invention will be described in more detail in the following Detailed Description, when taken in conjunction with the following drawings, in which like reference numerals refer to like elements throughout.

FIG. 1 is a perspective view of a portion of an apparatus according to this invention, particularly illustrating a sludge removal dredge with a screen box removably placed atop the dredge;

FIG. 2 is a perspective view of the dredge and screen box shown in FIG. 1, but illustrating the screen box prior to the installation of the screen box atop the dredge;

FIG. 3 is a perspective view of the top of the screen box of FIG. 1;

FIG. 4 is a perspective view of the top of the screen box of FIG. 1, but with the lid of the screen box having been swung open to illustrate the basket shaped filter screen inside the screen box;

FIG. 5 is a side elevational view of the dredge and the attached screen box inside a waste pit underlying the floor of a structure used to raise animals, particularly illustrating the dredge being used to perform the sludge removal portions of a method according to this invention;

FIG. 6 is an enlarged side elevational view of the dredge and the attached screen box inside a waste pit being used to remove sludge from the bottom of the waste pit, but with portions of the dredge and the screen box being broken away to illustrate the flow of the removed sludge material through the dredge and the screen box and through an output hose leading upwardly from the screen box, the illustration further showing an input hose for adding liquid to the waste pit as part of the method of this invention; and

FIG. 7 is a diagrammatic side elevational view of another portion of the apparatus of this invention, particularly illustrating a shaker table for dewatering the sludge that has been removed and pumped out of the waste pit to thereby recover the sludge in a solid, granular form that may be used as a fertilizer.

### DETAILED DESCRIPTION

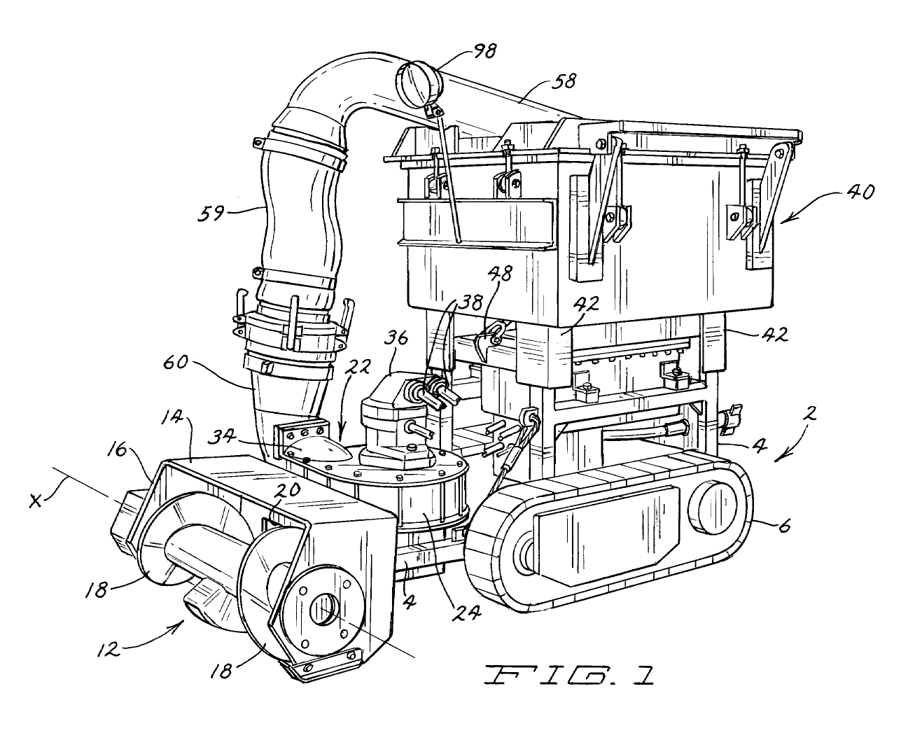

Referring first to FIG. 1, the apparatus of this invention comprises a submersible dredge that is generally indicated as 2 in the drawings. Dredge 2 includes a dredge frame 4 that is propelled by a pair of laterally spaced, left and right, endless crawler tracks 6. Only the left track 6 is shown in FIG. 1 with the right track 6 being hidden in FIG. 1 by other portions of the structure of dredge 2.

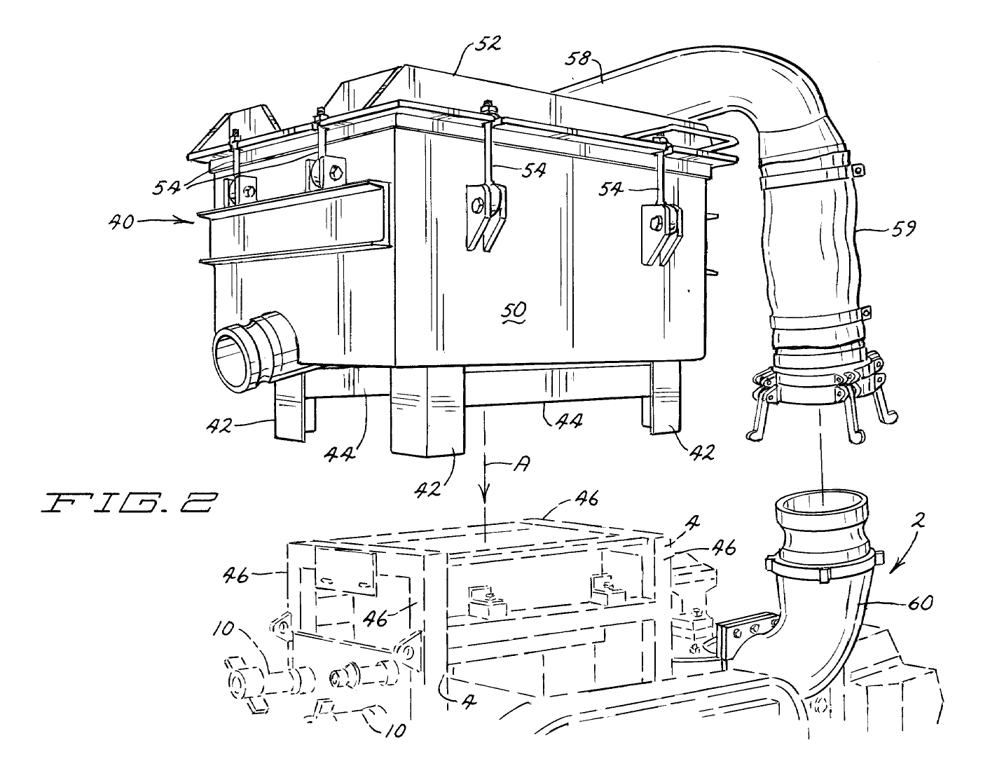

Dredge frame 4 includes a hydraulic traction motor (not shown) for powering tracks 6 such that dredge frame 4 is self-propelled. The hydraulic traction motor receives a flow of pressurized hydraulic fluid from a remote source of such fluid, e.g. from a master hydraulic pump (not shown), that is located away from dredge 2. For example, when dredge 2 is being used in a waste pit 8 to perform the sludge removal method of this invention, the master hydraulic pump can be located outside the structure in which the animals are being raised. The master hydraulic pump will be connected by a pair of long hydraulic hoses (not shown) to a pair of hydraulic hose couplings 10 carried on dredge frame 4 (see FIG. 2) which lead to a hydraulic manifold on dredge frame 4. Thus, dredge frame 4 has a source of pressurized hydraulic fluid being supplied thereto by the master hydraulic pump. Some of this pressurized fluid is used for powering the traction motor that propels tracks 6 in both forward and reverse.

Dredge frame 4 has a horizontally disposed auger 12 at the front thereof with auger 12 being rotatably journalled inside an auger housing 14 for rotation about a substantially horizontal rotational axis x. Auger housing 14 has an open forwardly facing mouth 16. Auger 12 has a pair of helical and oppositely directed auger blades 18 that engage sludge and move the engaged sludge inwardly from each side of auger housing 14 towards the center of auger housing 14. The back wall of auger housing 14 has a discharge opening 20 at the center thereof so that the sludge that has been gathered by auger 12 and moved inwardly by auger 12 relative to auger housing 14 will be brought by auger 12 to discharge opening 20. In this sense, auger 12 works and functions very similarly to the auger of a two stage snowthrower.

Auger 12 has powered rotation about the rotational axis x. This can be done in any suitable manner. For example, auger 12 could be powered by its own independent hydraulic motor from some of the pressurized hydraulic fluid being supplied to dredge 2 from the remote master hydraulic pump. Alternatively, a mechanical drive train of some type could power auger 12 from the hydraulic traction motor that is used to power tracks 6.

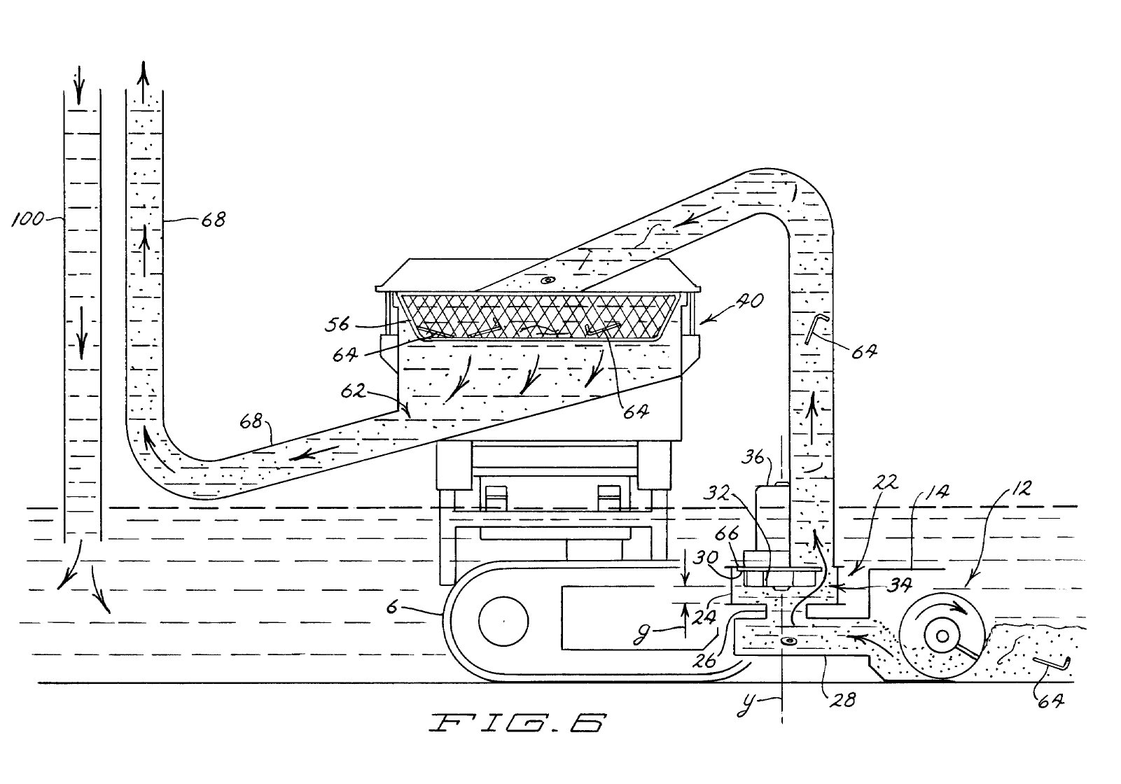

Referring now to FIGS. 1 and 6, a vane type pump 22 is provided having a substantially cylindrical pump housing 24 that is situated on dredge frame 4 immediately behind auger housing 14. Pump housing 24 has a bottom inlet 26 that is connected to discharge opening 20 of auger housing 14 by a short connecting duct 28. Pump 22 comprises a substantially flat, support disc 30 having three downwardly extending vanes 32 thereon which are circumferentially spaced around support disc 30 at substantially equal intervals. Support disc 30 of pump 22 rotates about a substantially vertical axis y as indicated in FIG. 6. One side of pump housing 24 has a discharge outlet 34 formed therein.

A hydraulic pump motor 36 sits atop pump housing 24 and has a drive shaft (not shown) that is connected to support disc 30 of pump 22 to rotate support disc 30 and to thereby rotate vanes 32. As this rotation occurs, pump 22 will draw or suction the sludge that has been gathered and augered inwardly by auger 12 from discharge opening 20 of auger housing 14, through bottom inlet 26 of pump 22, and will then eject or pump this sludge out through the side discharge outlet 34 of pump 22 at great force. Pump motor 36 is hydraulically driven from the pressurized fluid flow that is being supplied to dredge frame 4 from the master hydraulic pump. The hydraulic supply and return lines 38 to pump motor 36 can be seen in FIG. 1.

Referring now to FIGS. 2-4, the apparatus of this invention also comprises a screen box 40 that can be releasably and removably attached to dredge frame 4 simply by placing or dropping screen box 40 onto the top of dredge frame 4. In this respect, screen box 40 has a plurality of downwardly extending L-shaped feet 42 at the bottom thereof. Bottom beams or rails 44 extend between feet 42 on each side of screen box 40.

As best shown in FIG. 2, after screen box 40 is hoisted over dredge frame 4 and is properly aligned relative to dredge frame 4, screen box 40 can then be dropped downwardly as indicated by the arrow A in FIG. 2. As this happens, L-shaped feet 42 act as guides and slide over the four corners 46 provided at the top of dredge frame 4. Eventually, bottom beams or rails 44 on screen box 40 simply abut against the top of dredge frame 4 with L-shaped feet 46 on screen box 40 having nested around corners 46 of dredge frame 4, all as shown in FIG. 1. In this position, screen box 40 simply rests by gravity atop dredge frame 4, with L-shaped feet 42 serving the additional function of holding screen box 40 on dredge frame 4 in the sense that screen box 40 cannot simply be pushed off dredge frame 4 due to the interference between feet 42 and corners 46 of dredge frame 44. Hooks or grapples 48 can further be used to secure screen box 40 atop dredge frame 4.

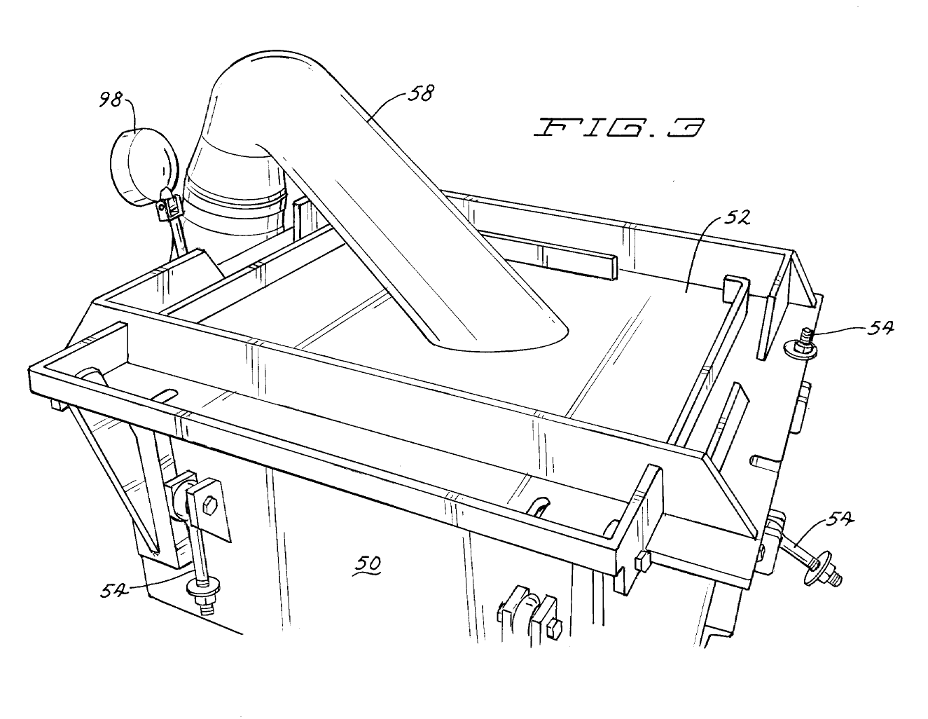

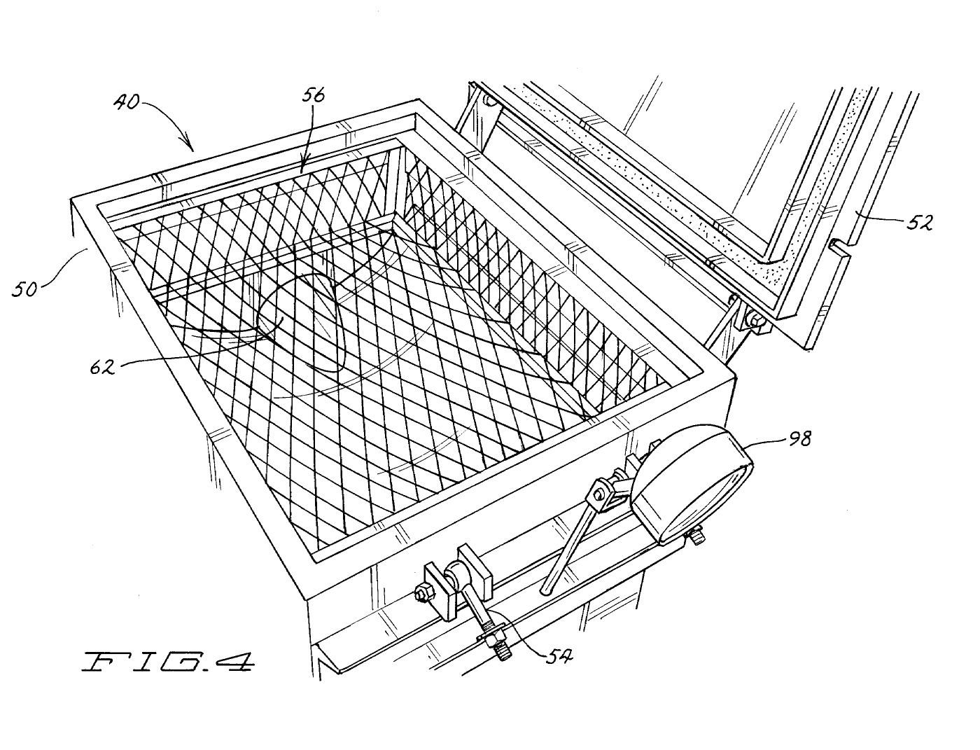

Basically, screen box 40 comprises a closed square or rectangular body 50 having a pivotal lid 52 at the top thereof. See FIG. 4. Releasable clamps 54 are provided between lid 52 and body 50 of screen box 40 to allow periodic access to a filter screen 56 contained inside screen box 40. Lid 52 is provided with an inlet duct 58 that can be coupled by a short, flexible coupling hose 59 to an outlet duct 60 leading away from side discharge outlet 34 of pump housing 24. See FIGS. 2 and 3. When outlet duct 60 on pump housing 24, coupling hose 59, and inlet duct 58 on screen box 40 are all clamped together by suitable hose clamps or couplings, screen box 40 is connected to pump 22 by a very short run of ducts and hose, on the order of a few feet. Thus, the sludge being pumped by pump 22 on dredge 2 only travels a few feet before entering screen box 40.

As best shown in FIG. 4, screen box 40 contains an upwardly facing, basket shaped filter screen 56. The basket shape of filter screen 56 is at least a few inches deep to provide filter screen 56 with the ability to hold a fair amount of debris before filter screen 56 has to be removed from screen box 40 for dumping of the debris. Filter screen 56 can be lifted up out of screen box 40, dumped, and then dropped back down into screen box 40 when lid 52 is open as shown in FIG. 4. The bottom of screen box 40 has an outlet 62 below the bottom of filter screen 56 through which the filtered sludge passes.

The mesh sizing of filter screen 56 is on the order of approximately an inch or so and is designed to catch relatively large foreign debris that might have fallen into the sludge. Examples of such debris are T-bolts 64 often used in the flooring and pens of the structure. Such T-bolts 64 are on the order of several inches long. Such T-bolts 64 can be seen in FIG. 6, both contained in the sludge, passing through pump 22, entering screen box 40, and being retained inside the basket shape of filter screen 56. T-bolts 64 are thus caught by screen box 40 substantially immediately after they were picked up by dredge 2 such that this large foreign debris is excluded from the stream of sludge that exits through outlet 62 of screen box 40.

It is important that vanes 32 of pump 22 have sufficient clearance to allow T-bolts 64 to pass through pump housing 24 without jamming vanes 32. In this respect, the bottoms of vanes 32 have been cut back from their usual depth to provide a much larger gap g between the bottoms of vanes 32 and the bottom of pump housing 24. Gap g is much larger than would normally be present. This gap g must be large enough to pass T-bolts 64 through pump housing 24 and through discharge outlet 34 contained in the side of pump housing 24 without jamming between the bottoms of vanes 32 and the bottom of pump housing 24. The Applicants have found that a gap g of approximately 2 inches works well in this regard.

In addition, it also preferable that support disc 30 of pump 22 sit up very close to the top of pump housing 24 so that there is substantially no gap between the two. The Applicants added an upwardly extending ring 66 to the top of support disc 30 of pump 22 such that the top of ring 66 is only approximately one eighth to one quarter of an inch below the top of pump housing 24. This prevents wires or similar elongated debris that might be present in the sludge from finding their way between support disc 30 of pump 22 and the top of pump housing 24 and wrapping themselves around the drive shaft of pump motor 36. Thus, pump 22 used in dredge 2 of this invention exhibits two modifications, namely more clearance between vanes 32 of pump 22 and the bottom of pump housing 24 and less clearance between support disc 30 of pump 22 and the top of pump housing 24, that is true of similar prior art dredges, such as the dredges manufactured by Liquid Waste Technology of Somerset, Wisconsin under the Pit Hog name.

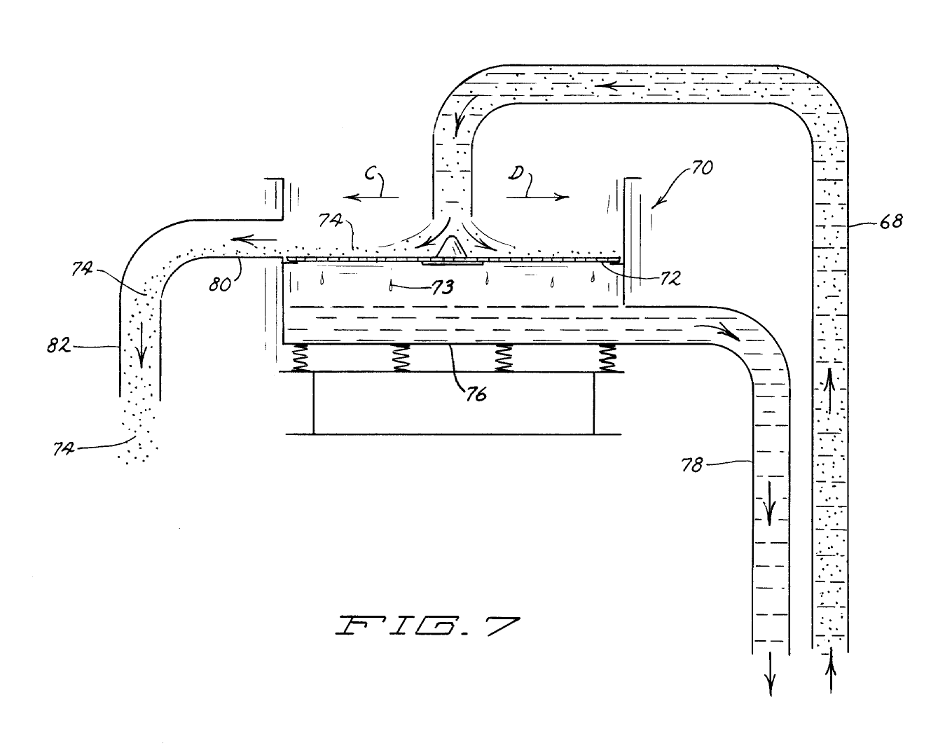

The filtered sludge leaving screen box 40 is then carried through a very long output hose 68 from a position inside waste pit 8 of the structure to a position on the exterior of the structure where a final piece of the apparatus of this invention is preferably located. That final piece of the apparatus, as shown in FIG. 7, is a powered shaker table 70 that is located outside the structure next to the structure. Such shaker tables 70 are well known in other industries for various purposes, such as for removing grit and fiber contaminants from a slurry that will be used to make paper. Various manufacturers of such shaker tables 70 are known, including Sweco and Kason.

Shaker table 70 is conceptually simple. It comprises a table containing a separating screen 72 having a very fine mesh size. Shaker table 70 is vibrated in some manner to have some type of rapid vibrating motion for vibrating or shaking separating screen 72 as indicated by the arrows C and D in FIG. 7. Output hose 68 carrying the filtered sludge to shaker table 70 dumps the filtered sludge down onto the top of separating screen 72. As separating screen 72 vibrates, the liquid in which the sludge was suspended for pumping is separated from the solid sludge material itself, which now assumes a much more granular or particulate form as shown at 74. The separated liquid 73 merely drops down through separating screen 72 and is collected in some type of trough or tank 76 from which the separated liquid can be led away through a liquid disposal hose 78. The potential reuse of this separated liquid in the sludge removal process itself will be described in more detail hereafter.

Meanwhile, the particulate sludge material 74 is simply vibrated off the side of separating screen 72. Particulate sludge material 74 can be collected in a trough or on a conveyor 80 that leads to a sludge recovery hose or chute 82. Particulate sludge material 74 passing through recovery chute 82 can then be directed to a wagon or bin for recovery and/or storage. Eventually, when the time is right for such a use, the recovered particulate sludge material 74 can be spread or applied to a farm field and used as fertilizer. Thus, the nutrients contained in particulate sludge material 74 will be reused and will not be wasted. This removal of the sludge material from waste pit 8 of the structure and its treatment through the dewatering process provided by shaker table 70 provides a valuable, nutrient rich, particulate fertilizer material 74 at practically no cost from a material, namely the sludge lying in waste pit 8, which is otherwise a waste disposal problem. It is believed that this recovered particulate sludge material 74 will be quite valuable to the owner or operator of the structure and could be sold commercially as a fertilizer.

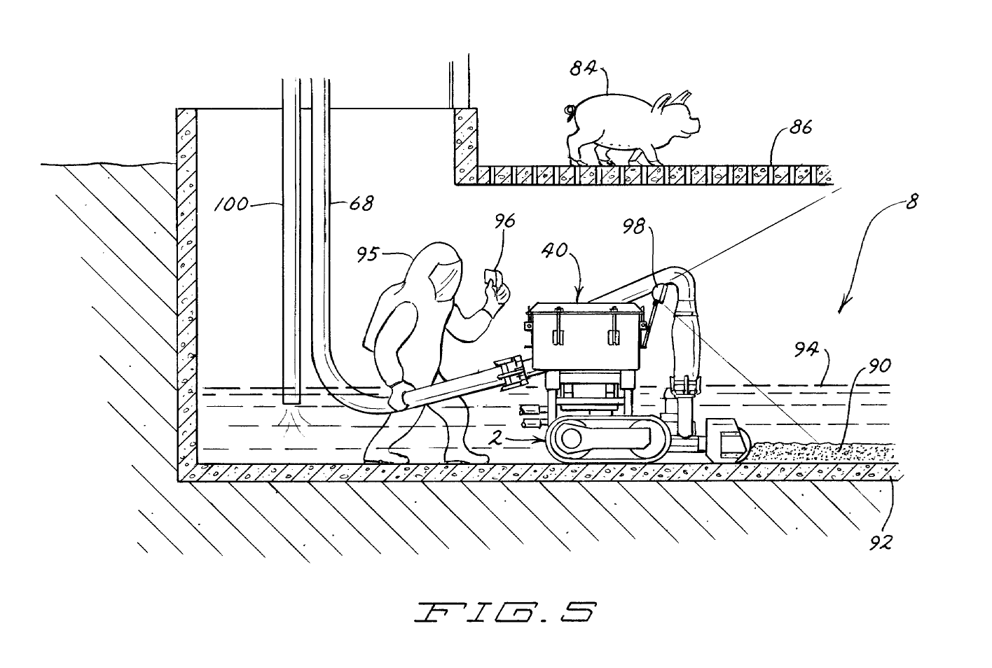

Now that the various parts of apparatus 2 of this invention have been described, the method of sludge removal, treatment and recovery of the sludge material as fertilizer can be set forth in reference to FIGS. 5-7. That method begins with a waste pit 8 beneath a structure with waste pit 8 having been filled to some degree by both liquid and solid animal waste products. In this respect, such liquid and solid animal waste products are being continuously created by the animals 84 inside the structure. The floor 86 of the structure is slatted such that the waste products from the animals merely drop through the slats in floor 86 to be deposited in waste pit 8.

The practitioner of the method of this invention will arrive at such a structure and find a layer of sludge 90 on the bottom 92 of waste pit 8 that will have a particular depth that may vary depending on how long sludge 90 has built up and this depth may or not be uniform. In other words, sludge 90 may have a greater depth in some spots, i.e. it will extend higher above bottom 92 of waste pit 8, than in other spots. There will also be a layer 94 of liquid waste atop sludge 90 though this liquid layer 94 may not completely cover sludge 90 over the entire surface of the body of sludge 90. In some spots where sludge 90 is quite deep, sludge 90 may stick up above the surface of liquid layer 94 much in the way that the tips of oceanic mountains stick up above the surface of the ocean to form islands.

In any event, if liquid layer 94 in waste pit 8 is quite deep, it is desirable to first reduce liquid layer 94 to a lower target level simply by pumping some of liquid layer 94 out of waste pit 8 in a generally conventional manner, i.e. by inserting a hose into waste pit 8 through a clean out port and by then pumping the liquid out of waste pit 8 through the hose using a pump connected to the hose. This pumped out liquid may be dumped onto the ground, or into a settling pond, or into a tank, etc. Some of this liquid may be reused as will be described hereafter. In any event, it is desirable that enough liquid be pumped out until a target level, e.g. about 2 feet, of liquid remains in waste pit 8. With such a reduced target level of liquid in waste pit 8, many areas of sludge 90 will stick up above the liquid level like icebergs or islands. If the operator arrives at waste pit 8 without enough liquid already present in waste pit 8, an extremely unlikely scenario, liquid would preferably have to be introduced by the operator to bring liquid layer 94 up to the target level. The target level can vary depending upon the preferences of the operator of dredge 2.

At some point, either before or after the pump out operation described above if such an operation is needed to reduce the liquid level to the target level, it is necessary to introduce dredge 2 and screen box 40 into waste pit 8. Dredge 2 and screen box 40 are separate from one another to allow this to be done through the typical and rather small clean out ports provided in the structure. There is enough room to pass a dredge through a typically sized port, but not if screen box 40 in pre-installed atop dredge 2. So, dredge 2 is passed through the clean out port, screen box 40 is passed separately through the clean out port, and then screen box 40 is lifted using a hoist or the like to assemble screen box 40 on top of dredge 2 after they both have been inserted into waste pit 8.

Then, all necessary hose connections are made, including connecting output hose 68 to the outlet of screen box 40 for carrying the filtered sludge from screen box 40 to the exterior of the structure. Meanwhile, one or more shaker tables 70 have been set up at some point close to the structure but on the exterior of the structure. Output hose 68 from screen box 40 is arranged to dump the filtered sludge leaving screen box 40 on the tops of the separating screens 72 of however many shaker tables 70 are provided.

Once the apparatus has been assembled in this manner and with liquid layer 94 being at the desired target level in waste pit 8, an operator 95, who is suitably garbed in protective clothing and using breathing apparatus, will enter waste pit 8 to operate and drive dredge 2 around on bottom 92 of waste pit 8. The idea essentially is to traverse over substantially the entire surface area of bottom 92 of waste pit 8. In this regard, the operator carries hand held controls 96 that can be used to engage the traction system of dredge 2 as well as the operation of auger 12 and pump 22 of dredge 2. The operator follows along behind dredge 2 as dredge 2 moves forwardly. To increase visibility, a light 98 is mounted on the front of screen box 40 to illuminate the path ahead of dredge 2.

As dredge 2 moves forwardly, auger 12 in auger housing 14 will gather sludge 90 and move it inwardly towards discharge opening 20 of auger housing 14. If sludge 90 is deep and extends up above liquid layer 94 in waste pit 8, the action of auger 12 causes sludge 90 to break or calve off in hunks like icebergs, with the hunks falling into the liquid left in waste pit 8 to turn into a suspension that pump 22 on dredge 2 is able to pump. This is why it is important to keep enough liquid in waste pit 8, namely so that the action of auger 12 on sludge 90 can turn sludge 90 into a suspension that pump 22 on dredge 2 can pump. If liquid layer 94 falls too far below the desired target level, additional liquid must be pumped back into waste pit 8 through a liquid supply hose 100. This liquid can be the liquid that is recovered from the dewatering process at shaker table 70 with the liquid disposal hose 78 comprising the liquid supply hose 100, or the liquid that has been previously recovered from shaker table 70 and stored somewhere for reuse, or even fresh water if need be. But, the liquid in liquid layer 94 must be high enough to allow sludge 90 to be sufficiently suspended such that it can be pumped.

As dredge 2 proceeds forwardly, auger 12 acts at any given time only on that small local portion of sludge 90 that auger 12 can reach and bite into. Auger 12 mechanically gathers and augers that local portion of sludge 90 to discharge opening 20 of auger 12 and causes that local portion of sludge 90 to go into a liquid suspension that can be pumped by virtue of mixing the local portion of sludge 90 with the available liquid 94 in waste pit 8. Pump 22 on dredge 2 than pumps this suspension through screen box 40, which catches and retains large foreign debris contained in the suspension, and then out through output hose 68 to shaker table 70. The action of dredge 2 at any one time is in a small local area of waste pit 8. But, because dredge 2 can be driven, the operator can simply drive it around waste pit 8 until it reaches and acts on every area of waste pit 8, making as many passes as need be until bottom 92 of waste pit 8 has been completely cleaned of sludge. This entire process can take many days depending on the size of waste pit 8.

However, once the sludge removal process is complete, bottom 92 of waste pit 8 will be substantially clear of the accumulated sludge 90 that may have built up over many years. The capacity of waste pit 8 to hold animal waste products from the animals living in the structure, and who can continue to live in the structure even while apparatus 2 of this invention is being used to perform the sludge removal operation just described, has been restored to its full design capacity. This extends the time before the owner or operator of the structure has to contemplate a similar sludge removal operation and also extends the time between periodic pump out operations that may be needed to remove only the liquid waste products from waste pit 8. It also greatly decreases the chances of having to conduct a pump out operation for removing liquid waste during the winter to thereby minimize the need in northern climates for obtaining regulatory approval for such an operation.

Even if the apparatus of this invention comprised only dredge 2 and only the steps described above for the sludge removal process per se, it would be a valuable advance in the art and something that the Applicants consider to be an invention of its own. However, with the addition of shaker table 70 outside the structure and the use of such a shaker table to dewater the suspension that comprises the filtered sludge that leaves screen box 40, the suspended sludge can be efficiently converted to a granular or particulate sludge material 74 that can be recovered and used as fertilizer. This is a further and separate aspect of this invention and would be useful no matter how one removes the sludge 90 from waste pit 8. Recovery of the nutrient rich sludge 90 and its reuse as a particulate fertilizer material 74 is a further aspect of this invention.

Various modifications of this invention will be apparent to those skilled in the art. For example, rather than using hydraulic traction and pump motors on dredge 2, one could use electric motors or dredge 2 could be moved over bottom 92 of waste pit 8 by some type of external towing system contained in the structure. While an auger 12 has been shown as part of dredge 2, other devices could be used to mechanically break off sludge 90 in a local area immediately ahead of dredge 2 and put such broken off sludge into liquid suspension, such as other rotatable bladed devices having rigid, pivotal or flexible blades (including flails). Accordingly, the scope of this invention is to be limited only by the appended claims.

We claim:

1. A method of removing sludge that has formed from solid animal waste products and that has accumulated on a bottom of a waste pit underlying a slatted floor of an animal holding structure, the waste pit also holding liquid animal waste products in addition to the accumulated sludge with both the liquid and solid animal waste products passing into the waste pit from the animals through the slatted floor, which comprises:
(a) inserting a dredge into the waste pit, the dredge having a powered, rotatable bladed device contained within a bladed device housing with the housing having an open mouth such that the bladed device can protrude at least partially through the mouth of the bladed device housing and contact and bite into the accumulated sludge in the waste pit with the bladed device housing further having a discharge opening, the dredge also having a powered pump in fluid communication with the discharge opening of the bladed device housing;
(b) rotating the bladed device within the bladed device housing for acting at any given time on a local portion of the sludge that is disposed ahead of the mouth of the bladed device housing such that the rotating bladed device breaks off the local sludge portion from a body of the sludge, puts such broken off local sludge portion into a liquid suspension with liquid contained in the waste pit, and moves such suspended local sludge portion towards the discharge opening in the bladed device housing;
(c) operating the pump simultaneously while rotating the bladed device such that the pump substantially continuously suctions the suspended local sludge portion moving to the discharge opening in the bladed device housing out of the bladed device housing and pumps such suspended local sludge portion out of the waste pit of the structure; and
(d) moving the dredge across the bottom of the waste pit while performing steps (b) and (c) such that the dredge repeats steps (b) and (c) on a plurality of local portions of the sludge to reduce the size of the body of sludge that was initially present on the bottom of the waste pit.

2. The method of claim 1, wherein the bladed device comprises an auger and the bladed device housing comprises a substantially horizontal auger housing, wherein the auger has at least one helically, extending auger blade extending along a length of the open mouth of the auger housing, and wherein the discharge opening of the auger housing is substantially narrower than the length of the open mouth of the auger housing.

3. The method of claim 1, wherein the dredge has a powered traction system for self-propulsion of the dredge across the bottom of the waste pit, and wherein the moving step comprises operating the traction system to allow the dredge to self propel itself across the bottom of the waste pit.

4. The method of claim 1, further including the step of screening the suspended local sludge portion being pumped in step (c) of claim 1 after the local sludge portion has left an outlet of the pump but while the local sludge portion is still within the waste pit such that the local sludge portion being pumped out of the structure comprises a screened local sludge portion.

5. The method of claim 4, wherein the screening step comprises passing the local sludge portion leaving the outlet of the pump through a screen box carried on the dredge.

6. The method of claim 5, wherein the screen box comprises a basket shaped filter screen having a relatively coarse mesh size to screen and retain pieces of foreign debris having a size greater than one inch.

7. The method of claim 1, further comprising the step of dewatering the local sludge portion being pumped out of the structure by removing the liquid holding the local sludge portion in liquid suspension such that the local sludge portion is converted into a solid, granular material suitable for use as fertilizer.

8. The method of claim 7, wherein the dewatering step comprises directing the local sludge portion while in liquid suspension onto a top of a vibratory screen of a shaker table, wherein the screen of the shaker table is vibrated at sufficient speed and has a sufficiently small mesh size such that the liquid holding the local sludge portion in suspension drips down through the vibratory screen while the solid, granular material left after removal of the liquid remains atop the vibratory screen.

9. The method of claim 8, further including the step of recovering the solid, granular material.

10. The method of claim 9, further including the step of spreading the recovered solid, granular material on a field as fertilizer.

11. The method of claim 1, further including the steps of:
(a) establishing a target liquid level for liquid in the waste pit which is sufficient to serve as a source of liquid for placing the local sludge portion into liquid suspension;
(b) pumping out liquid waste products from the waste pit if an initial liquid level of the liquid waste products is above the target liquid level or adding liquid to the waste pit if the initial liquid level of the liquid waste products is below the target liquid level; and
(c) adding additional liquid to the waste pit as liquid in the waste pit is used in steps (b) and (c) of claim 1 to place into liquid suspension the local sludge portions acted on by the bladed device, the liquid adding step occurring after an actual liquid level in the waste pit drops below the target liquid level to thereby maintain the actual liquid level at the target liquid level.

12. The method of claim 11, wherein the target liquid level is approximately two feet above the bottom of the waste pit.

13. The method of claim 11, further comprising the steps of:
(a) dewatering the local sludge portion being pumped out of the structure by removing the liquid holding the local sludge portion in liquid suspension such that the screened local sludge portion is converted into a solid, granular material; and
(b) using at least a portion of the liquid removed from the local sludge portion in the dewatering step as a source for the liquid added back to the waste pit in step (c) of claim 11 to maintain the actual liquid level at the target liquid level.

14. A plant fertilizer material produced according to the method of claim 7.

15. An apparatus for removing sludge that has formed from solid animal water products and that has accumulated on a bottom of a waste pit underlying a slatted floor of an animal holding structure, which comprises:
(a) a dredge which comprises:
(i) a dredge frame that is movably supported to allow the dredge frame to move across the bottom of the waste pit;
(ii) a substantially horizontal, powered auger rotatable within a substantially horizontal auger housing on the dredge frame, the auger housing having an open mouth that permits the auger to bite into and contact a local portion of a body of sludge on the bottom of the waste pit and move such local sludge portion towards a discharge opening in the auger housing;
(iii) a powered pump carried on the dredge frame having an inlet in fluid communication with the discharge opening in the auger housing, the pump having an outlet with the pump being driven at sufficient force to draw a liquid suspension holding the local sludge portion broken off by the auger through the discharge opening of the auger housing, through the pump, and out through an outlet hose to a location outside of the structure; and
(b) a screen box carried atop the dredge frame for filtering the liquid suspension of the local sludge portion, the screen box having a filter screen for receiving and retaining pieces of foreign debris that may be present within the local sludge portion.

16. The apparatus of claim 15, wherein the pump comprises a support disc rotatably received within a generally circular pump housing, wherein the support disc carries a plurality of circumferentially spaced vanes on one face thereof with the vanes having a clearance relative to one surface of the pump housing having the pump inlet that is sufficiently long to permit foreign debris longer than one inch to pass through the pump housing, the filter screen having a mesh size that will catch and retain such foreign debris so that the local sludge portion passing through the screen box comprises a filtered local sludge portion.

17. The apparatus of claim 16, wherein an opposite face of the support disc is spaced from an opposite surface of the pump housing by a gap that no larger than approximately ¼ inch to prevent elongated foreign debris from wrapping around a drive shaft extending to the support disc.

18. The apparatus of claim 15, wherein the barn or other structure includes a clean out port leading into the waste pit, wherein the dredge has a size that permits the dredge to be inserted into the waste pit through the clean out port, wherein the screen box has a size that permits the screen box to be inserted into the waste pit through the clean out port separately from the dredge, and wherein the screen box is removably installed on top of the dredge in situ in the waste port after both the dredge and the screen box have been separately placed through the clean out port.

19. The apparatus of claim 15, wherein the filter screen is a basket shaped filter screen, and wherein the filter screen is removable from the screen box for periodic dumping of the contents of the filter screen.

20. The apparatus of claim 15, further including a shaker table having a vibratory screen located outside the structure, the local sludge portion that is being pumped out of the waste pit by the pump being directed on top of the vibratory screen of the shaker table to allow dewatering of the local sludge portion to convert the local sludge portion back into a solid, granular material and into the liquid that had previously held the solid, granular material in liquid suspension.
